(19) United States
(12) Patent Application Publication
(10) Pub. No.: US 2025/0007556 A1
(43) Pub. Date: Jan. 2, 2025

(54) PARTIAL FREQUENCY SOUNDING WITH START RB LOCATION HOPPING

(71) Applicant: LENOVO (BEIJING) LIMITED, Beijing (CN)

(72) Inventors: Bingchao LIU, Beijing (CN); Lingling XIAO, Beijing (CN); Chenxi ZHU, Fairfax, VA (US); Wei LING, Beijing (CN); Yi ZHANG, Beijing (CN)

(21) Appl. No.: 18/694,344

(22) PCT Filed: Sep. 29, 2021
(86) PCT No.: PCT/CN2021/121681

§ 371 Date: Mar. 21, 2024

(51) Int. Cl. H04B 1/7143; H04B 7/06

(52) U.S. Cl. CPC H04B 1/7143; H04B 7/0626

(57) ABSTRACT

Methods and apparatuses for partial frequency sounding with start RB location hopping are disclosed. A method comprises receiving a configuration on start RB location hopping pattern for an SRS resource configured with partial frequency sounding and with hops in each frequency hopping (FH) period, wherein the start RB location hopping pattern for partial frequency sounding factor P_{F} has P_{F} elements, and each element in the start RB location hopping pattern is selected from a set of values {0, 1, . . . , P_{F}−1}; and determining the start RB location for each hop in each frequency hopping (FH) period according to the start RB location hopping pattern.

### FIELD

The subject matter disclosed herein generally relates to wireless communications, and more particularly relates to methods and apparatuses for partial frequency sounding with start RB location hopping.

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC), User Entity/Equipment (Mobile Terminal), Transmitter (TX), Receiver (RX), Sounding Reference Signal (SRS), frequency range 2 (FR2): indicating a frequency range of 24.25 GHz-52.6 GHz, Downlink control information (DCI), Media Access Control (MAC), MAC control element (MAC CE), Radio Resource Control (RRC), Resource Block (RB), RB level partial frequency sounding (RPFS), Frequency Hopping (FH), frequency domain resource allocation (FDRA), time domain resource allocation (TDRA), Hybrid Automatic Repeat request (HARQ).

Basic SRS function is specified in NR Release 15. The SRS function is enhanced in NR Release 16 to support high efficiency operation in FR2.

SRS resource can be configured as aperiodic SRS, semi-persistent SRS or periodic SRS. Aperiodic SRS resource can be triggered by DCI (e.g. DCI format 0_1 or DCI format 1_1) with a non-zero ‘SRS request’ field. Semi-persistent SRS resource is activated or deactivated by a Semi-persistent SRS Activation/Deactivation MAC CE. Periodic SRS resource can be triggered by a higher layer signaling (e.g. RRC signaling).

The SRS capacity, especially for the UE with lower mobility in small delay spread scenario, needs to be improved. One way to improve the SRS capacity is partial frequency sounding, which means that the SRS resource(s) is only transmitted on partial frequency band of the allocated frequency resources in a sounding hop. Each sounding hop corresponds to a sounding subband in a symbol. In frequency domain, SRS transmission should cover the frequency band that is of interest for the scheduler. One way is by means of narrower band SRS transmission, i.e., hopping in the frequency domain or frequency hopping. In this way, a sequence of SRS transmissions jointly covers the frequency band of interest. Each SRS transmission corresponds to a sounding hop. And each frequency hopping period is the period to sound the full frequency band of interest across the different subbands.

Traditionally, the frequency resources used for a SRS resource is determined by the number of RBs (m_{SRS,B}_{_{SRS}}) configured for the SRS resource. The number of RBs (m_{SRS,B}_{_{SRS}}) is determined by the RRC parameter C_{SRS} and B_{SRS} configured per SRS resource, as illustrated in Table 1 which is specified in 3GPP technical specification TS38.211 v16.0.0.

TABLE 1

| | B_{SRS} = 0 | | B_{SRS} = 1 | | B_{SRS} = 2 | | B_{SRS} = 3 | |
|---|---|---|---|---|---|---|---|---|
| C_{SRS} | m_{SRS, 0} | N₀ | m_{SRS, 1} | N₁ | m_{SRS, 2} | N₂ | m_{SRS, 3} | N₃ |
| 0 | 4 | 1 | 4 | 1 | 4 | 1 | 4 | 1 |
| 1 | 8 | 1 | 4 | 2 | 4 | 1 | 4 | 1 |
| 2 | 12 | 1 | 4 | 3 | 4 | 1 | 4 | 1 |
| 3 | 16 | 1 | 4 | 4 | 4 | 1 | 4 | 1 |
| 4 | 16 | 1 | 8 | 2 | 4 | 2 | 4 | 1 |
| 5 | 20 | 1 | 4 | 5 | 4 | 1 | 4 | 1 |
| 6 | 24 | 1 | 4 | 6 | 4 | 1 | 4 | 1 |
| 7 | 24 | 1 | 12 | 2 | 4 | 3 | 4 | 1 |
| 8 | 28 | 1 | 4 | 7 | 4 | 1 | 4 | 1 |
| 9 | 32 | 1 | 16 | 2 | 8 | 2 | 4 | 2 |
| 10 | 36 | 1 | 12 | 3 | 4 | 3 | 4 | 1 |
| 11 | 40 | 1 | 20 | 2 | 4 | 5 | 4 | 1 |
| 12 | 48 | 1 | 16 | 3 | 8 | 2 | 4 | 2 |
| 13 | 48 | 1 | 24 | 2 | 12 | 2 | 4 | 3 |
| 14 | 52 | 1 | 4 | 13 | 4 | 1 | 4 | 1 |
| 15 | 56 | 1 | 28 | 2 | 4 | 7 | 4 | 1 |
| 16 | 60 | 1 | 20 | 3 | 4 | 5 | 4 | 1 |
| 17 | 64 | 1 | 32 | 2 | 16 | 2 | 4 | 4 |
| 18 | 72 | 1 | 24 | 3 | 12 | 2 | 4 | 3 |
| 19 | 72 | 1 | 36 | 2 | 12 | 3 | 4 | 3 |
| 20 | 76 | 1 | 4 | 19 | 4 | 1 | 4 | 1 |
| 21 | 80 | 1 | 40 | 2 | 20 | 2 | 4 | 5 |
| 22 | 88 | 1 | 44 | 2 | 4 | 11 | 4 | 1 |
| 23 | 96 | 1 | 32 | 3 | 16 | 2 | 4 | 4 |
| 24 | 96 | 1 | 48 | 2 | 24 | 2 | 4 | 6 |
| 25 | 104 | 1 | 52 | 2 | 4 | 13 | 4 | 1 |
| 26 | 112 | 1 | 56 | 2 | 28 | 2 | 4 | 7 |
| 27 | 120 | 1 | 60 | 2 | 20 | 3 | 4 | 5 |
| 28 | 120 | 1 | 40 | 3 | 8 | 5 | 4 | 2 |
| 29 | 120 | 1 | 24 | 5 | 12 | 2 | 4 | 3 |
| 30 | 128 | 1 | 64 | 2 | 32 | 2 | 4 | 8 |
| 31 | 128 | 1 | 64 | 2 | 16 | 4 | 4 | 4 |
| 32 | 128 | 1 | 16 | 8 | 8 | 2 | 4 | 2 |
| 33 | 132 | 1 | 44 | 3 | 4 | 11 | 4 | 1 |
| 34 | 136 | 1 | 68 | 2 | 4 | 17 | 4 | 1 |
| 35 | 144 | 1 | 72 | 2 | 36 | 2 | 4 | 9 |
| 36 | 144 | 1 | 48 | 3 | 24 | 2 | 12 | 2 |
| 37 | 144 | 1 | 48 | 3 | 16 | 3 | 4 | 4 |
| 38 | 144 | 1 | 16 | 9 | 8 | 2 | 4 | 2 |
| 39 | 152 | 1 | 76 | 2 | 4 | 19 | 4 | 1 |
| 40 | 160 | 1 | 80 | 2 | 40 | 2 | 4 | 10 |
| 41 | 160 | 1 | 80 | 2 | 20 | 4 | 4 | 5 |
| 42 | 160 | 1 | 32 | 5 | 16 | 2 | 4 | 4 |
| 43 | 168 | 1 | 84 | 2 | 28 | 3 | 4 | 7 |
| 44 | 176 | 1 | 88 | 2 | 44 | 2 | 4 | 11 |
| 45 | 184 | 1 | 92 | 2 | 4 | 23 | 4 | 1 |
| 46 | 192 | 1 | 96 | 2 | 48 | 2 | 4 | 12 |
| 47 | 192 | 1 | 96 | 2 | 24 | 4 | 4 | 6 |
| 48 | 192 | 1 | 64 | 3 | 16 | 4 | 4 | 4 |
| 49 | 192 | 1 | 24 | 8 | 8 | 3 | 4 | 2 |
| 50 | 208 | 1 | 104 | 2 | 52 | 2 | 4 | 13 |
| 51 | 216 | 1 | 108 | 2 | 36 | 3 | 4 | 9 |
| 52 | 224 | 1 | 112 | 2 | 56 | 2 | 4 | 14 |
| 53 | 240 | 1 | 120 | 2 | 60 | 2 | 4 | 15 |
| 54 | 240 | 1 | 80 | 3 | 20 | 4 | 4 | 5 |
| 55 | 240 | 1 | 48 | 5 | 16 | 3 | 8 | 2 |
| 56 | 240 | 1 | 24 | 10 | 12 | 2 | 4 | 3 |
| 57 | 256 | 1 | 128 | 2 | 64 | 2 | 4 | 16 |
| 58 | 256 | 1 | 128 | 2 | 32 | 4 | 4 | 8 |
| 59 | 256 | 1 | 16 | 16 | 8 | 2 | 4 | 2 |
| 60 | 264 | 1 | 132 | 2 | 44 | 3 | 4 | 11 |
| 61 | 272 | 1 | 136 | 2 | 68 | 2 | 4 | 17 |
| 62 | 272 | 1 | 68 | 4 | 4 | 17 | 4 | 1 |
| 63 | 272 | 1 | 16 | 17 | 8 | 2 | 4 | 2 |

One way to improve the SRS capacity is partial frequency sounding, which means that the SRS resource(s) is only transmitted on partial frequency band of the allocated frequency resources in a sounding hop. It has been agreed to support that the UE only transmits the SRS resource in mₚ (mₚ is the largest integer that is equal to or smaller than

$$⌊ \frac{1}{{P}_{F}} {m}_{SRS , {B}_{S R S}} ⌋$$

) contiguous RBs in one OFDM symbol, where m_{SRS,B}_{_{SRS}} indicates the number of RBs for a sounding hop configured by RRC signaling, P_{F} (partial frequency sounding factor) is a number that is larger than 1 (e.g. 2, 4 or 8) so that only partial frequency band is used to transmit the SRS resource. Incidentally, if P_{F}=1, the SRS resource(s) is transmitted on all the allocated frequency resources in a sounding hop. In other words, the partial frequency sounding is disabled if P_{F}=1.

Although partial frequency sounding in RB level brings power boosting gain, i.e., the limited power is transmitted in a narrow band and the power for each RE with SRS transmission is boosted compared with full frequency sounding with P_{F}=1, channel estimation accuracy may deteriorate significantly in some RBs without actual SRS transmission, especially for large P_{F} value(s).

FIG. 1 illustrates a prior art RB level partial frequency sounding (RPFS). In FIG. 1, the partial frequency sounding factor P_{F} is equal to 4, the start RB location (i.e. start RB index) of the

$$\frac{1}{{P}_{F}} {m}_{SRS , {B}_{S R S}} {m}_{SRS , {B}_{S R S}} RBs is {N}_{offset} = \frac{{k}_{F}}{{P}_{F}} {m}_{SRS , {B}_{S R S}} ,$$

where m_{SRS,B}_{_{SRS}} indicates the number of RBs for a sounding hop configured by RRC signaling, k_{F} indicates the start RB offset in the m_{SRS,B}_{_{SRS}} RBs, and k_{F}=0 in FIG. 1. In one Frequency Hopping (FH) period, there are 8 sounding hops configured for frequency hopping. It can be seen from FIG. 1 that in each of the hops 1 to 8, SRS is always transmitted in the first

$$\frac{1}{{P}_{F}} {m}_{S R S , {B}_{S R S}} ( = \frac{1}{4} {m}_{S R S , {B}_{S R S}} )$$

On the other hand, no SRS is transmitted in any frequency bands starting from

$$\frac{1}{4} {m}_{SRS , {B}_{S R S}}$$

to m_{SRS,B}_{_{SRS}} in any FH period.

It is expected that SRS can be transmitted in all m_{SRS,B}_{_{SRS}} frequency bands for each hop to improve channel estimation accuracy.

This disclosure targets the above issue.

### BRIEF SUMMARY

Methods and apparatuses for partial frequency sounding with start RB location hopping are disclosed.

In one embodiment, a method comprises receiving a configuration on start RB location hopping pattern for an SRS resource configured with partial frequency sounding and with hops in each frequency hopping (FH) period, wherein the start RB location hopping pattern for partial frequency sounding factor P_{F} has P_{F} elements, and each element in the start RB location hopping pattern is selected from a set of values {0,1, . . . , P_{F}−1}; and determining the start RB location for each hop in each frequency hopping (FH) period according to the start RB location hopping pattern.

In one embodiment, the start RB location hopping pattern may be directly configured to the SRS resource. Alternatively in another embodiment, the start RB location hopping pattern may be configured by a hopping pattern ID. In particular, for P_{F}=2, hopping pattern ID 0 corresponds to start RB location hopping pattern {0, 1}; and hopping pattern ID 1 corresponds to start RB location hopping pattern {1, 0}, for P_{F}=4, hopping pattern ID 0 corresponds to start RB location hopping pattern {0, 2, 1, 3}; hopping pattern ID 1 corresponds to start RB location hopping pattern {2, 1, 3, 0}; hopping pattern ID 2 corresponds to start RB location hopping pattern {1, 3, 0, 2}; and hopping pattern ID 3 corresponds to start RB location hopping pattern {3, 0, 2, 1}, and for P_{F}=8, hopping pattern ID 0 corresponds to start RB location hopping pattern {0, 4, 2, 6, 1, 5, 3, 7}; hopping pattern ID 1 corresponds to start RB location hopping pattern {4, 2, 6, 1, 5, 3, 7, 0}; hopping pattern ID 2 corresponds to start RB location hopping pattern {2, 6, 1, 5, 3, 7, 0, 4}; hopping pattern ID 3 corresponds to start RB location hopping pattern {6, 1, 5, 3, 7, 0, 4, 2}; hopping pattern ID 4 corresponds to start RB location hopping pattern {1, 5, 3, 7, 0, 4, 2, 6}; hopping pattern ID 5 corresponds to start RB location hopping pattern {5, 3, 7, 0, 4, 2, 6, 1}; hopping pattern ID 6 corresponds to start RB location hopping pattern {3, 7, 0, 4, 2, 6, 1, 5}; and hopping pattern ID 7 corresponds to start RB location hopping pattern {7, 0, 4, 2, 6, 1, 5, 3}.

In yet another embodiment, the start RB location hopping pattern may be configured by one element of the start RB location hopping pattern that applies to the first hop of the first frequency hopping period, and the start RB location hopping pattern is determined by a cyclic pattern of a basic hopping pattern according to the one element. The one element of the start RB location hopping pattern may be indicated by an unused field of a DCI without data and without CSI if aperiodic SRS resource(s) are triggered by the DCI.

In some embodiment, the {(n mod P_{F})+1}^{th} element in the start RB location hopping pattern may apply to the start RB location of the SRS resource in all hops of the n^{th} FH period. In this condition, the start RB location hopping pattern periodically applies to the every P_{F} FH periods.

In some other embodiment, the

$${\{ ( {n}_{S R S} = ⌊ \frac{{l}^{′}}{R} ⌋ ) mod {P}_{F} + 1 \}}^{th}$$

element of the start RB location hopping pattern may apply to the start RB location of the SRS resource in the l′^{th} hop, where R is the SRS repetition number. In this condition, the start RB location hopping pattern periodically changes in P_{F} contiguous FH periods.

In yet other embodiment, the {(l′)mod P_{F}+1}^{th} element of the start RB location hopping pattern may apply to the start RB location of the SRS resource in the l′^{th} hop, where R is the SRS repetition number. In this condition, the start RB location hopping pattern periodically changes in P_{F}/R contiguous FH periods.

In one embodiment, a method at a base unit comprises transmitting a configuration on start RB location hopping pattern for an SRS resource configured with partial frequency sounding and with hops in each frequency hopping (FH) period, wherein the start RB location hopping pattern for partial frequency sounding factor P_{F} has P_{F} elements, and each element in the start RB location hopping pattern is selected from a set of values {0,1, . . . , P_{F}−1}; and determining the start RB location for each hop in each frequency hopping (FH) period according to the start RB location hopping pattern

In another embodiment, a remote unit (e.g. UE) comprises a receiver that receives a configuration on start RB location hopping pattern for an SRS resource configured with partial frequency sounding and with hops in each frequency hopping (FH) period, wherein the start RB location hopping pattern for partial frequency sounding factor P_{F} has P_{F} elements, and each element in the start RB location hopping pattern is selected from a set of values {0,1, . . . , P_{F}−1} and a processor that determines the start RB location for each hop in each frequency hopping (FH) period according to the start RB location hopping pattern.

In yet another embodiment, a base unit comprises a transmitter that transmits a configuration on start RB location hopping pattern for an SRS resource configured with partial frequency sounding and with hops in each frequency hopping (FH) period, wherein the start RB location hopping pattern for partial frequency sounding factor P_{F} has P_{F} elements, and each element in the start RB location hopping pattern is selected from a set of values {0,1, . . . , P_{F}−1} and a processor that determines the start RB location for each hop in each frequency hopping (FH) period according to the start RB location hopping pattern.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 illustrates a prior art RB level partial frequency sounding (RPFS);

FIG. 2 illustrates an example of start RB location hopping for RPFS;

FIG. 3 illustrates an example of partial frequency sounding with start RB location hopping for all the SRS resources for different UEs;

FIG. 4 illustrates an example of the third embodiment in which SRS repetition is configured along with start RB location hopping within FH period, while a same start RB location is determined for the repeated SRS symbols, and different start RB locations apply to SRS in different hops;

FIG. 5 illustrates an example of a variety of the third embodiment in which SRS repetition is configured along with start RB location hopping within FH period, while different start RB locations are determined for different SRS symbols regardless the SRS resource is configured with or without repetition;

FIG. 6 is a schematic flow chart diagram illustrating an embodiment of a method;

FIG. 7 is a schematic flow chart diagram illustrating a further embodiment of a method; and

FIG. 8 is a schematic block diagram illustrating apparatuses according to one embodiment.

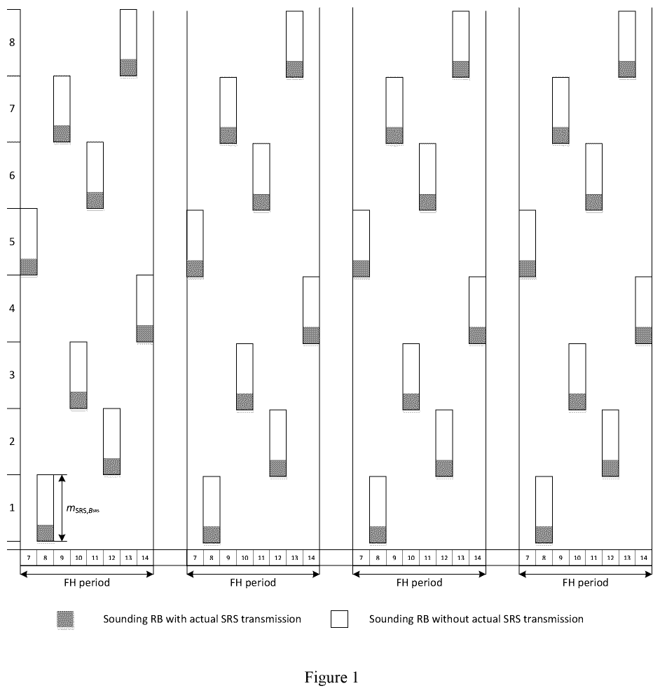

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

A first embodiment relates to start RB location hopping for RB-level partial frequency sounding (RPFS).

According to the first embodiment, the start RB location (i.e. start RB index) of the

$$\frac{1}{{P}_{F}} {m}_{S R S , {B}_{S R S}}$$

RBs in the m_{SRS,B}_{_{SRS}} RBs can be hopped in different frequency hopping (FH) periods, where m_{SRS,B}_{_{SRS}} indicates the number of RBs for a sounding hop configured by RRC signaling, P_{F} is the partial frequency sounding factor. The initial start RB position

$${N}_{offset} = \frac{{k}_{F}}{{P}_{F}} {m}_{SRS , {B}_{S R S}} , {k}_{F} = \{ 0 , … , {P}_{F} - 1 \} .$$

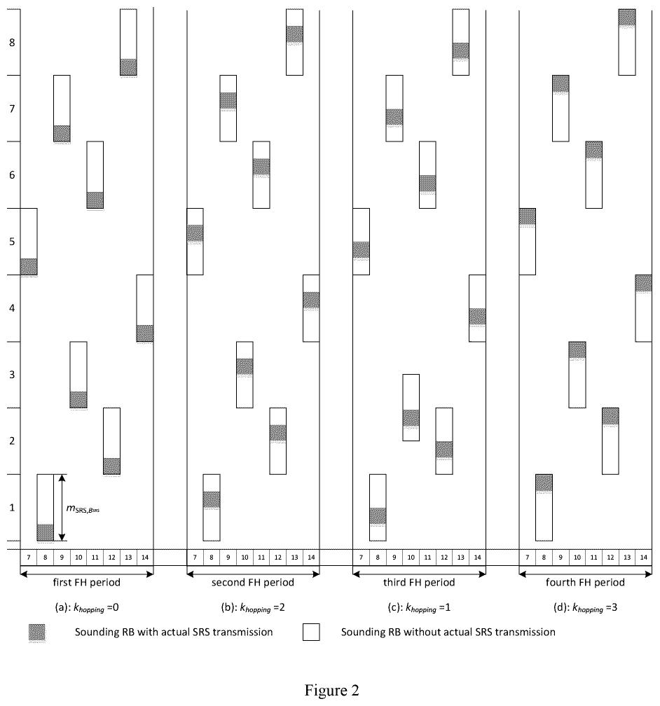

FIG. 2 provides an example of start RB location hopping for RPFS, where the partial frequency sounding factor P_{F}=4, k_{F}=0 and 8 hops are configured for frequency hopping (i.e. there are 8 hops in one Frequency Hopping (FH) period,) with m_{SRS,B}_{_{SRS}} being a multiple of 4 (e.g. C_{SRS}=9, i.e. m_{SRS,B}_{_{SRS}} is 32 or 16 or 8 or 4). SRS resources for 8 hops are transmitted in the last 8 symbols in one slot, e.g., the first hop is transmitted in the seventh symbol, the second hop is transmitted in the eighth symbol, the third hop is transmitted in the ninth symbol, the fourth hop is transmitted in the tenth symbol, the fifth hop is transmitted in the eleventh symbol, the sixth hop is transmitted in the twelfth symbol, the seventh hop is transmitted in the thirteenth symbol, the eighth hop is transmitted in the fourteenth symbol.

The allocated sounding band is m_{SRS,B}_{_{SRS}}. It can be seen that the UE only transmits SRS on ¼ allocated sounding band (i.e.

$$\frac{1}{{P}_{F}} {m}_{S R S , {B}_{S R S}}$$

) in each symbol. According to the first embodiment, the start RB location for each FH period is determined by start RB location offset equation

$${N}_{o f f s e t} = \frac{( {k}_{F} + {k}_{h o p p i n g} ) mod {P}_{F}}{{P}_{F}} {m}_{S R S , {B}_{SRS}} ,$$

where P_{F} is partial frequency sounding factor; k_{F}∈ {0,1, . . . , P_{F}−1} is another parameter configured along with P_{F} to determine the start RB location if partial frequency hopping is configured (in the following disclosure, k_{F} is always configured to be 0); m_{SRS,B}_{_{SRS}} indicates the number of RBs for a sounding hop configured by RRC signaling; k_{hopping} is determined by start RB location hopping pattern.

In FIG. 2, in the FH period shown in (a), the start RB location is

$${N}_{offset} = \frac{( {k}_{F} + {k}_{h o p p i n g} ) mod {P}_{F}}{{P}_{F}} {m}_{SRS , {B}_{S R S}} = \frac{( 0 + 0 ) mod 4}{4} \times {m}_{SRS , {B}_{S R S}} = 0 ,$$

where k_{hopping}=0; in the FH period shown in (b), the start RB location is

$${N}_{offset} = \frac{( {k}_{F} + {k}_{h o p p i n g} ) mod {P}_{F}}{{P}_{F}} {m}_{SRS , {B}_{S R S}} = \frac{( 0 + 2 ) mod 4}{4} \times {m}_{SRS , {B}_{S R S}} = \frac{1}{2} \times {m}_{S R S , {B}_{SRS}} ,$$

where k_{hopping}=2; in the FH period shown in (c), the start RB location is

$${N}_{offset} = \frac{( {k}_{F} + {k}_{h o p p i n g} ) mod {P}_{F}}{{P}_{F}} {m}_{S R S , {B}_{S R S}} = \frac{( 0 + 1 ) mod 4}{4} \times {m}_{SRS , {B}_{S R S}} = \frac{1}{4} \times {m}_{S R S , {B}_{S R S}} ,$$

where k_{hopping}=1; and in the FH period shown in (d), the start RB location is

$${N}_{offset} = \frac{( {k}_{F} + {k}_{h o p p i n g} ) mod {P}_{F}}{{P}_{F}} {m}_{SRS , {B}_{S R S}} = \frac{( 0 + 3 ) mod 4}{4} \times {m}_{SRS , {B}_{S R S}} = \frac{3}{4} \times {m}_{S R S , {B}_{S R S}} ,$$

where k_{hopping}=3. Note that the FH periods shown in (a), (b), (c) and (d) are 4 contiguous FH periods. For example, (a) corresponds to the first FH period, (b) corresponds to the second FH period, (c) corresponds to the third FH period and (d) corresponds to the fourth FH period.

From the example shown in FIG. 2, in the first FH period shown in (a), k_{hopping}=0; in the second FH period shown in (b), k_{hopping}=2; in the third FH period shown in (c), k_{hopping}=1; and in the fourth FH period shown in (d), k_{hopping}=3. It can be seen that a hopping pattern {0, 2, 1, 3} with P_{F} (i.e. partial frequency sounding factor, which is equal to 4 in the example of FIG. 2) values is applied to P_{F} contiguous FH periods, so that each of the allocated sounding bands 1 to 8 are sounded in P_{F} (=4) contiguous FH periods. So, the following observations can be made:
(1) All allocated sounding bands can be sounded by configuring appropriate start RB location hopping pattern.
(2) All allocated sounding bands can be sounded within P_{F} (e.g. P_{F}=4 in FIG. 2) contiguous FH periods.
(3) The length of hopping pattern (e.g. pattern {0, 2, 1, 3} in FIG. 2) is equal to P_{F}.
(4) The valid element of hopping pattern or the valid start RB location with hopping k_{hopping} ∈ {0, 1, . . . , P_{F}− 1} (e.g. k_{hopping} ∈ {0, 1, 2, 3} in FIG. 2). That is, each element of the hopping pattern is selected from a different value of {0, 1, . . . , P_{F}−1}. In other words, the values of k_{hopping} are different in the contiguous P_{F} FH periods, and selected from a set of values {0, 1, . . . , P_{F}}.
(5) The configured hopping pattern will periodically apply to each FH period and begin from the first FH period. For example, the pattern {0, 2, 1, 3} applies to four (equal to P_{F}) contiguous FH periods shown in FIG. 2 and will continue to apply to next P_{F} (equal to 4) FH periods (not shown in FIG. 2).

A second embodiment relates to specifying hopping pattern to an SRS resource.

According to a first sub-embodiment of the second embodiment, a fixed hopping pattern corresponding to each P_{F} value is predetermined. A hopping offset (or hopping pattern index (ID)) is configured for each SRS resource or each SRS resource set along with P_{F} and k_{F}. Note that the hopping offset (or hopping pattern ID) configured to an SRS resource set applies to all SRS resources within the SRS resource set. If the hopping offset or hopping pattern ID is not configured for an SRS resource, the UE assumes that start RB location hopping is disabled for the SRS resource, i.e., the UE shall assume k_{hopping}=0 for the SRS resource.

For example, the following hopping patterns corresponding to different P_{F} values are proposed:

For P_{F}=2, the start RB location hopping pattern is configured as {0, 1} for hopping pattern ID 0. The start RB location hopping pattern for periodic and semi-persistent SRS with P_{F}=2 is shown in Table 2.

TABLE 2

| hopping offset | k_{hopping} to be applied to the n^{th} FH period of | |
|---|---|---|
| (or hopping | periodic of semi-persistent SRS resource | |
| pattern ID) | n mod P_{F} = 0 | n mod P_{F} = 1 |
| 0 | 0 | 1 |
| 1 | 1 | 0 |

For P_{F}=4, the start RB location hopping pattern is configured as {0, 2, 1, 3} for hopping pattern ID 0. The start RB location hopping pattern for periodic and semi-persistent SRS with P_{F}=4 is shown in Table 3.

TABLE 3

| hopping offset | k_{hopping} to be applied to the n^{th} FH period of | | | |
|---|---|---|---|---|
| (or hopping | periodic of semi-persistent SRS resource | | | |
| pattern ID) | n mod P_{F} = 0 | n mod P_{F} = 1 | n mod P_{F} = 2 | n mod P_{F} = 3 |
| 0 | 0 | 2 | 1 | 3 |
| 1 | 2 | 1 | 3 | 0 |
| 2 | 1 | 3 | 0 | 2 |
| 3 | 3 | 0 | 2 | 1 |

For P_{F}=8, the start RB location hopping pattern is configured as {0, 4, 2, 6, 1, 5, 3, 7} for hopping pattern ID 0. The start RB location hopping pattern for periodic and semi-persistent SRS with P_{F}=8 is shown in Table 4.

TABLE 4

| hopping | k_{hopping} to be applied to the n^{th} FH period of | | | | | | | |
|---|---|---|---|---|---|---|---|---|
| offset (or | periodic of semi-persistent SRS resource | | | | | | | |
| hopping | n mod | n mod | n mod | n mod | n mod | n mod | n mod | n mod |
| pattern ID) | P_{F} = 0 | P_{F} = 1 | P_{F} = 2 | P_{F} = 3 | P_{F} = 4 | P_{F} = 5 | P_{F} = 6 | P_{F} = 7 |
| 0 | 0 | 4 | 2 | 6 | 1 | 5 | 3 | 7 |
| 1 | 4 | 2 | 6 | 1 | 5 | 3 | 7 | 0 |
| 2 | 2 | 6 | 1 | 5 | 3 | 7 | 0 | 4 |
| 3 | 6 | 1 | 5 | 3 | 7 | 0 | 4 | 2 |
| 4 | 1 | 5 | 3 | 7 | 0 | 4 | 2 | 6 |
| 5 | 5 | 3 | 7 | 0 | 4 | 2 | 6 | 1 |
| 6 | 3 | 7 | 0 | 4 | 2 | 6 | 1 | 5 |
| 7 | 7 | 0 | 4 | 2 | 6 | 1 | 5 | 3 |

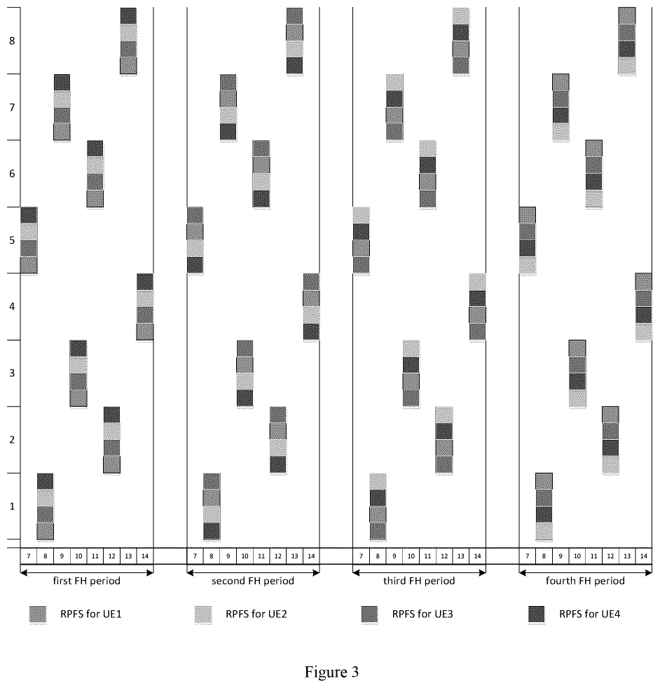

FIG. 3 illustrates an example of partial frequency sounding with start RB location hopping for all the SRS resources for different UEs (e.g. four UEs), where P_{F}=4, k_{F}=0, and 8 hops are configured in one FH period with m_{SRS,B}_{_{SRS}} being a multiple of 4 (e.g. C_{SRS}=9 illustrated in Table 1, i.e. m_{SRS,B}_{_{SRS}} is 32 or 16 or 8 or 4). A hopping offset or hopping pattern ID with value 0 is configured for the SRS for UE1 (i.e. hopping pattern of {0, 2, 1, 3} with reference to Table 3), a hopping offset or hopping pattern ID with value 1 is configured for the SRS for UE2 (i.e. hopping pattern of {2, 1, 3, 0} with reference to Table 3), a hopping offset or hopping patter ID with value 2 is configured for the SRS for UE3 (i.e. hopping pattern of {1, 3, 0, 2} with reference to Table 3), and a hopping offset or hopping patter ID with value 3 is configured for the SRS for UE4 (i.e. hopping pattern of {3, 0, 2, 1} with reference to Table 3).

Instead of configuring the hopping offset (hopping pattern ID) to the UE, the gNB may alternatively configure the k_{hopping} for the first hopping period of the SRS resource for a UE. The UE can derivate the k_{hopping} for each FH period (i.e. hopping pattern) of a periodic or semi-persistent SRS resource according to Table 2 (for P_{F}=2) or Table 3 (for P_{F}=4) or Table 4 (for P_{F}=8), according to the configured k_{hopping} for the first hopping period. For example, for the example shown in FIG. 3, the gNB may configure k_{hopping}=0 for the SRS for UE1, configure k_{hopping}=2 for the SRS for UE2, configure k_{hopping}=1 for the SRS for UE3, and configure k_{hopping}=3 for the SRS for UE4.

According to a second sub-embodiment of the second embodiment, a hopping pattern (or a hopping sequence) with length P_{F} may be directly configured to an SRS resource. If the hopping pattern is not configured for an SRS resource, the UE assumes that start RB location hopping is disabled for the SRS resource, i.e., the UE shall assume k_{hopping}=0 for the SRS resource.

That is, a hopping pattern corresponding to a different hopping offset can be directly configured to each SRS resource. For the example shown in FIG. 3, the hopping pattern {0, 2, 1, 3} is configured to the SRS resource of UE 1, the hopping pattern {2, 1, 3, 0} is configured to the SRS resource of UE 2, the hopping pattern {1, 3, 0, 2} is configured to the SRS resource of UE 3, the hopping pattern {3, 0, 2, 1} is configured to the SRS resource of UE 4.

The start RB location hopping pattern related parameters (e.g. hopping pattern ID, or k_{hopping} value for the first FH period, or hopping pattern) for periodic and/or semi-persistent SRS resources can be configured by RRC signaling along with P_{F} and k_{F} for each SRS resource.

If the start RB location hopping pattern is enabled for aperiodic SRS, the start RB location hopping pattern related parameters can be indicated by the DCI triggering the aperiodic SRS. For example, if one SRS resource set is triggered by a DCI without data and without CSI triggering, the unused field, e.g., FDRA field, TDRA field or HARQ processing number indicator field, of the DCI can be used to indicate a k_{hopping}∈{0, 1, . . . , P_{F}−1} (or hopping pattern ID or hopping pattern) for the triggered SRS resource set(s). In this case, the indicated k_{hopping} applies to all the SRS resources contained in the triggered SRS resource set(s).

A third embodiment relates to start RB location hopping within legacy FH period. In the first embodiment as shown in FIG. 2, the start RB location hops among different FH periods, while in each of the hops 1 to 8 in the same FH period, the start RB location is fixed. Similarly, in the second embodiment as shown in FIG. 3, the start RB location for a certain UE hops among different FH periods, while in each of the hops 1 to 8 in the same FH period, the start RB location for the certain UE is fixed (e.g. in the first FH period, the start RB location in each of the hops 1 to 8 for UE1 is 0). According to the third embodiment, the start RB location can hop within different hops in the same FH period.

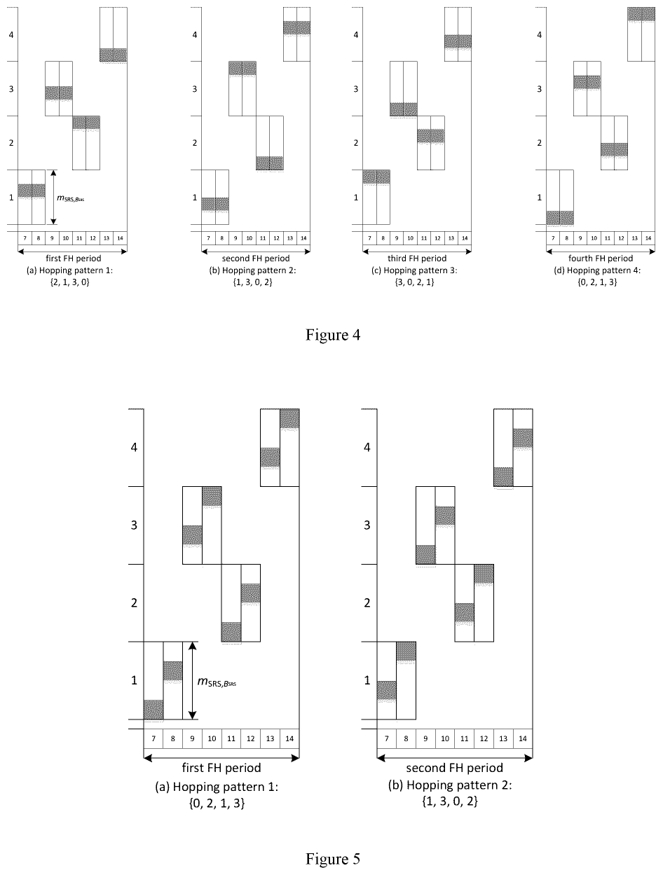

FIG. 4 illustrates an example of the third embodiment in which SRS repetition is configured along with start RB location hopping within FH period, while a same start RB location is determined for the repeated SRS symbols, and different start RB locations apply to SRS in different hops. In FIG. 4, there are 4 hops (i.e. hops 1 to 4) in one frequency hopping (FH) period. In addition, in each of hops 1 to 4, SRS is repeatedly transmitted twice (i.e. R=2).

If

$${n}_{S R S} = ⌊ \frac{{l}^{′}}{R} ⌋$$

is the number of SRS transmissions with l′∈{0, 1, . . . , N_{symb}^{SRS}−1}, where N_{symb}^{SRS} is the number of OFDM symbols used for SRS transmission (N_{symb}^{SRS}=8 in FIG. 4), and R is the SRS repetition number (R=2 in FIG. 4), the UE determines the start RB location for each SRS symbol of the SRS transmission according to (n_{SRS} mod P_{F}) and the indicated hopping pattern (P_{F}=4 in FIG. 4). That is, the ((n_{SRS} mod P_{F})+1)^{th} k_{hopping} in the indicated hopping pattern applies to the (l′+1)^{th} SRS symbol.

In (a) of FIG. 4, the start RB location hopping pattern (i.e. hopping pattern 1) is configured to {2, 1, 3, 0} (i.e. the first to the fourth k_{hopping} are 2, 1, 3, 0). The consecutive OFDM symbols used for SRS transmission are symbols 7 to 14, i.e. N_{symb}^{SRS}=8. Accordingly, l′ ∈ {0, 1, 2, 3, 4, 5, 6, 7} representing symbols 7, 8, 9, 10, 11, 12, 13 and 14, respectively.

$${n}_{SRS} = ⌊ \frac{{l}^{′}}{R} ⌋ = \{ ⌊ 0 / 2 ⌋ , ⌊ 1 / 2 ⌋ ⌊ 2 / 2 ⌋ , ⌊ 3 / 2 ⌋ , ⌊ 4 / 2 ⌋ , ⌊ 5 / 2 ⌋ , ⌊ 6 / 2 ⌋ , ⌊ 7 / 2 ⌋ \} = \{ 0 , 0 , 1 , 1 , 2 , 2 , 3 , 3 \} .$$

n_{SRS} mod P_{F}=n_{SRS} mod 4={0, 0, 1, 1, 2, 2, 3, 3}. So, by applying the ((n_{SRS} mod P_{F})+1)^{th} k_{hopping} in the indicated hopping pattern to the (l′+1)^{th} SRS symbol, k_{hopping} {2, 2, 1, 1, 3, 3, 0, 0} are applied to the first to the eighth SRS symbol (i.e. symbols 7, 8, 9, 10, 11, 12, 13 and 14), respectively. Based on the start RB location equation

$${N}_{offset} = \frac{( {k}_{F} + {k}_{hopping} ) mod {P}_{F}}{{P}_{F}} {m}_{SRS , {B}_{SRS}}$$

(k_{F}=0 in FIG. 4), the start RB positions for the SRS transmission in symbols 7 to 14 (with l′ equal to 0 to 7) are {2/4, 2/4, 1/4, 1/4, 3/4, 3/4, 0/4, 0/4}×m_{SRS,B}_{_{SRS}}={1/2, 1/2, 1/4, 1/4, 3/4, 3/4, 0, 0}×m_{SRS,B}_{_{SRS}}.

If the same hopping pattern (e.g. hopping pattern 1 of {2, 1, 3, 0}) applies to following FH periods, the same start RB position will periodically apply to all the hops across all the FH periods and begin from the first hop of the first FH period. For example, the start RB position for the first hop (i.e. hop 1) with 2 repetitions in all FH periods is always

$$\frac{1}{2} \times {m}_{SRS , {B}_{SRS}} .$$

According to the third embodiment, the hopping pattern periodically changes in P_{F} contiguous FH periods, so that each hop (e.g. each of hops 1 to 4) in the P_{F} contiguous FH periods occupies a whole of m_{SRS,B}_{_{SRS}} RBs. For example, as shown in FIG. 4, in the first FH period (a), the hopping pattern 1 {2, 1, 3, 0} (i.e. hopping pattern ID 1 in Table 3) is configured; in the second FH period (b), the hopping pattern 2 {1, 3, 0, 2} (i.e. hopping pattern ID 2 in Table 3) is configured; in the third FH period (c), the hopping pattern 3 {3, 0, 2, 1} (i.e. hopping pattern ID 3 in Table 3) is configured; and in the fourth FH period (d), the hopping pattern 4 {0, 2, 1, 3} (i.e. hopping pattern ID 0 in Table 3) is configured. In other words, each of the four hopping pattern IDs 0 to 3 in Table 3 is configured to one FH period of the four contiguous FH periods. Accordingly, in P_{F} (=4) contiguous FH periods, SRS is transmitted in all m_{SRS,B}_{_{SRS}} frequency bands. For example, the start RB position for the first hop (i.e. hop 1) with 2 repetitions in the first FH period is

$$\frac{1}{2} \times {m}_{SRS , {B}_{SRS}} ;$$

the start RB position for the first hop (i.e. hop 1) with 2 repetitions in the second FH period is

$$\frac{1}{4} \times {m}_{SRS , {B}_{SRS}} ;$$

the start RB position for the first hop (i.e. hop 1) with 2 repetitions in the third FH period is

$$\frac{3}{4} \times {m}_{SRS , {B}_{SRS}} ;$$

and the start RB position for the first hop (i.e. hop 1) with 2 repetitions in the fourth FH period is 0. Accordingly, across P_{F} (=4) contiguous FH periods, a whole of m_{SRS,B}_{_{SRS}} sound bands are occupied (i.e. with SRS transmitted) for the first hop (i.e. hop 1). Similarly, across P_{F} (=4) contiguous FH periods, a whole of m_{SRS,B}_{_{SRS}} sound bands are occupied (i.e. with SRS transmitted) for each of hop 2, hop 3 and hop 4.

FIG. 5 illustrates an example of a variety of the third embodiment in which SRS repetition is configured along with start RB location hopping within FH period, while different start RB locations are determined for different SRS symbols regardless the SRS resource is configured with or without repetition.

In the example of FIG. 5, a different start RB location is determined for the repeated SRS symbols, and different start RB locations apply to SRS in different hops based on the indicated hopping pattern. In FIG. 5, there are 4 hops (i.e. hops 1 to 4) in one frequency hopping (FH) period. In addition, in each of hops 1 to 4, SRS is repeatedly transmitted twice (i.e. R=2) although in different frequency bands.

The UE determines the start RB location for each SRS symbol according to (l′ mod P_{F}) and the indicated hopping pattern. That is, the ((l′ mod P_{F})+)^{th} k_{hopping} in the indicated hopping pattern applies to the (l′+1)^{th} SRS symbol.

In (a) of FIG. 5, the start RB location hopping pattern (i.e. hopping pattern 1) is configured to {0, 2, 1, 3} (i.e. the first to the fourth k_{hopping}). The consecutive OFDM symbols used for SRS transmission are symbols 7 to 14, i.e. N_{symb}^{SRS}=8. Accordingly, l′∈{0, 1, 2, 3, 4, 5, 6, 7}. l′ mod P_{F}=l′ mod 4={0, 1, 2, 3, 0, 1, 2, 3}. So, by applying the ((l′ mod P_{F})+1)^{th} k_{hopping} in the indicated hopping pattern to the (l′+1)^{th} SRS symbol, k_{hopping} {0, 1, 2, 3, 0, 1, 2, 3} are applied to the first to the eighth SRS symbol (i.e. symbols 7, 8, 9, 10, 11, 12, 13 and 14), respectively. Based on the start RB location equation

$${N}_{offset} = \frac{( {k}_{F} + {k}_{hopping} ) mod {P}_{F}}{{P}_{F}} {m}_{SRS , {B}_{SRS}}$$

(k_{F}=0 in FIG. 5), the start RB positions for symbols 7 to 14 (with l′ equal to 0 to 7) are {0/4, 2/4, 1/4, 3/4, 0/4, 2/4, 1/4, 3/4}×m_{SRS,B}_{_{SRS}}={0, 1/2, 1/4, 3/4, 0, 1/2, 1/4, 3/4}×m_{SRS,B}_{_{SRS}}.

If the same hopping pattern (e.g. hopping pattern 1 of {0, 2, 1, 3}) applies to following FH period(s), the same start RB positions will periodically apply to all the hops across all the FH periods and begin from the first hop of the first FH period. For example, the start RB positions for the first hop (i.e. hop 1) with 2 repetitions in all FH periods are always 0 and

$$\frac{1}{2} \times {m}_{SRS , {B}_{SRS}} .$$

According to the variety of the third embodiment, the hopping pattern periodically changes in P_{F}/R contiguous FH periods, so that each hop in the P_{F}/R contiguous FH periods occupy a whole of m_{SRS,B}_{_{SRS}} RBs.

For example, as shown in FIG. 5, in the first FH period (a), the hopping pattern 1 {0, 2, 1, 3} (i.e. hopping pattern ID 0 in Table 3) is configured; and in the second FH period (b), the hopping pattern 2 {1, 3, 0, 2} (i.e. hopping pattern ID 2 in Table 3) is configured. In other words, P_{F}/R hopping pattern IDs are configured to P_{F}/R contiguous FH periods. The P_{F}/R hopping pattern IDs should be selected so that all k_{hopping} values are present in the first R elements of the P_{F}/R hopping patterns (e.g. all even hopping pattern IDs or all odd hopping pattern IDs if R=2). For example, the first R (=2) elements of the P_{F}/R (=2) hopping pattern IDs 0 and 2 are respectively 0, 2 and 1, 3. So, all k_{hopping} values 0, 1, 2, and 3 are present. Accordingly, the start RB positions for the first hop (i.e. hop 1) with 2 repetitions in the first FH period are 0 and

$$\frac{1}{2} \times {m}_{SRS , {B}_{SRS}} ;$$

and the start RB positions for the first hop (i.e. hop 1) with 2 repetitions in the second FH period are

$$\frac{1}{4} \times {m}_{SRS , {B}_{SRS}} and \frac{3}{4} \times {m}_{SRS , {B}_{SRS}} .$$

Accordingly, across P_{F}/R (=2) contiguous FH periods, a whole of m_{SRS,B}_{_{SRS}} sound bands are occupied (i.e. with SRS transmitted) for the first hop (i.e. hop 1). Similarly, across P_{F}/R (=2) contiguous FH periods, a whole of m_{SRS,B}_{_{SRS}} sound bands are occupied (i.e. with SRS transmitted) for each of hop 2, hop 3 and hop 4.

The SRS resource can be aperiodic, periodic and/or semi-persistent. For aperiodic SRS resource, the gNB may configure or indicate a hopping pattern for an aperiodic SRS resource by RRC or DCI. For periodic and/or semi-persistent SRS resources, the UE periodically applies the indicated hopping pattern to the SRS symbols of each SRS resource.

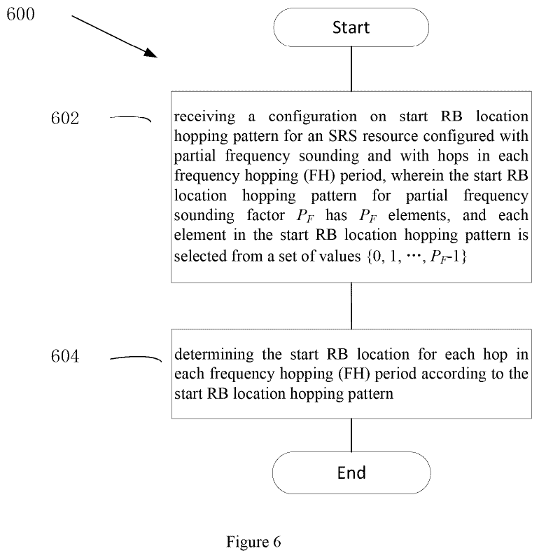

FIG. 6 is a schematic flow chart diagram illustrating an embodiment of a method 600 according to the present application. In some embodiments, the method 600 is performed by an apparatus, such as a base unit. In certain embodiments, the method 600 may be performed by a processor executing program code, for example, a microcontroller, a microprocessor, a CPU, a GPU, an auxiliary processing unit, a FPGA, or the like.

The method 600 may comprise 602 receiving a configuration on start RB location hopping pattern for an SRS resource configured with partial frequency sounding and with hops in each frequency hopping (FH) period, wherein the start RB location hopping pattern for partial frequency sounding factor P_{F} has P_{F} elements, and each element in the start RB location hopping pattern is selected from a set of values {0,1, . . . , P_{F}−1}; and 604 determining the start RB location for each hop in each frequency hopping (FH) period according to the start RB location hopping pattern.

The start RB location hopping pattern may be directly configured to the SRS resource. Alternatively, the start RB location hopping pattern may be configured by a hopping pattern ID. In particular, for P_{F}=2, hopping pattern ID 0 corresponds to start RB location hopping pattern {0, 1}; and hopping pattern ID 1 corresponds to start RB location hopping pattern {1, 0}, for P_{F}=4, hopping pattern ID 0 corresponds to start RB location hopping pattern {0, 2, 1, 3}1; hopping pattern ID 1 corresponds to start RB location hopping pattern {2, 1, 3, 0}; hopping pattern ID 2 corresponds to start RB location hopping pattern {1, 3, 0, 2}; and hopping pattern ID 3 corresponds to start RB location hopping pattern {3, 0, 2, 1}, and for P_{F}=8, hopping pattern ID 0 corresponds to start RB location hopping pattern {0, 4, 2, 6, 1, 5, 3, 7}; hopping pattern ID 1 corresponds to start RB location hopping pattern {4, 2, 6, 1, 5, 3, 7, 0}; hopping pattern ID 2 corresponds to start RB location hopping pattern {2, 6, 1, 5, 3, 7, 0, 4}; hopping pattern ID 3 corresponds to start RB location hopping pattern {6, 1, 5, 3, 7, 0, 4, 2}; hopping pattern ID 4 corresponds to start RB location hopping pattern {1, 5, 3, 7, 0, 4, 2, 6}; hopping pattern ID 5 corresponds to start RB location hopping pattern {5, 3, 7, 0, 4, 2, 6, 1}; hopping pattern ID 6 corresponds to start RB location hopping pattern {3, 7, 0, 4, 2, 6, 1, 5}; and hopping pattern ID 7 corresponds to start RB location hopping pattern {7, 0, 4, 2, 6, 1, 5, 3}.

The start RB location hopping pattern may be configured by one element of the start RB location hopping pattern that applies to the first hop of the first frequency hopping period, and the start RB location hopping pattern is determined by a cyclic pattern of a basic hopping pattern according to the one element. The one element of the start RB location hopping pattern may be indicated by an unused field of a DCI without data and without CSI if aperiodic SRS resource(s) are triggered by the DCI.

The {(n mod P_{F})+1}^{th} element in the start RB location hopping pattern may apply to the start RB location of the SRS resource in all hops of the n^{th} FH period. In this condition, the start RB location hopping pattern periodically applies to the every P_{F} FH periods.

The

$${\{ ( {n}_{SRS} = ⌊ \frac{{l}^{′}}{R} ⌋ ) mod {P}_{F} + 1 \}}^{th}$$

element of the start RB location hopping pattern may apply to the start RB location of the SRS resource in the l′^{th} hop, where R is the SRS repetition number. In this condition, the start RB location hopping pattern periodically changes in P_{F} contiguous FH periods.

The {(l′)mod P_{F}+1}^{th} element of the start RB location hopping pattern may apply to the start RB location of the SRS resource in the l′^{th} hop, where R is the SRS repetition number. In this condition, the start RB location hopping pattern periodically changes in P_{F}/R contiguous FH periods.

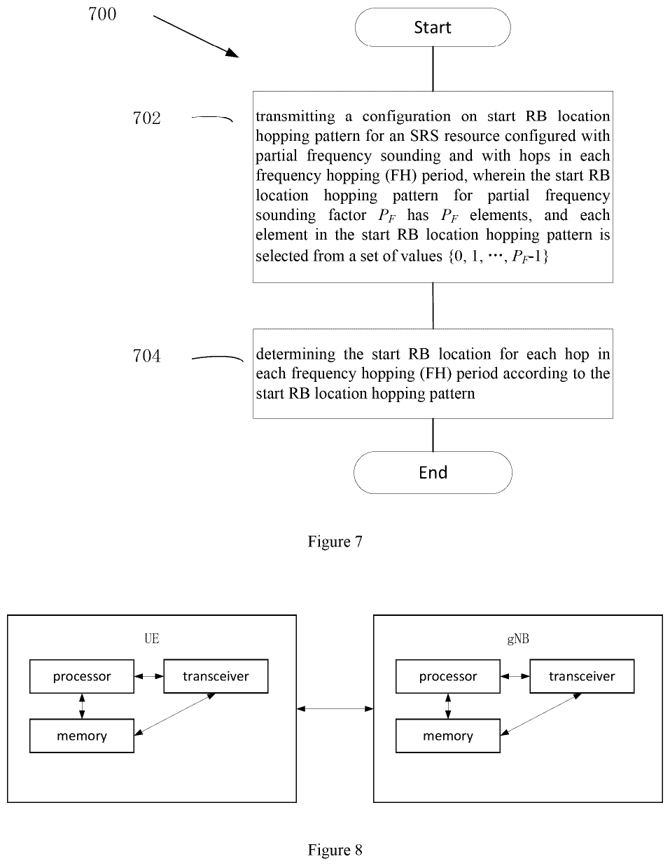

FIG. 7 is a schematic flow chart diagram illustrating a further embodiment of a method 700 according to the present application. In some embodiments, the method 700 is performed by an apparatus, such as a remote unit. In certain embodiments, the method 700 may be performed by a processor executing program code, for example, a microcontroller, a microprocessor, a CPU, a GPU, an auxiliary processing unit, a FPGA, or the like.

The method 700 may comprise 702 transmitting a configuration on start RB location hopping pattern for an SRS resource configured with partial frequency sounding and with hops in each frequency hopping (FH) period, wherein the start RB location hopping pattern for partial frequency sounding factor P_{F} has P_{F} elements, and each element in the start RB location hopping pattern is selected from a set of values {0,1, . . . , P_{F}−1}; and 704 determining the start RB location for each hop in each frequency hopping (FH) period according to the start RB location hopping pattern.

The start RB location hopping pattern may be directly configured to the SRS resource. Alternatively, the start RB location hopping pattern may be configured by a hopping pattern ID. In particular, for P_{F}=2, hopping pattern ID 0 corresponds to start RB location hopping pattern {0, 1}; and hopping pattern ID 1 corresponds to start RB location hopping pattern {1, 0}, for P_{F}=4, hopping pattern ID 0 corresponds to start RB location hopping pattern {0, 2, 1, 3}; hopping pattern ID 1 corresponds to start RB location hopping pattern {2, 1, 3, 0}; hopping pattern ID 2 corresponds to start RB location hopping pattern {1, 3, 0, 2}; and hopping pattern ID 3 corresponds to start RB location hopping pattern {3, 0, 2, 1}, and for P_{F}=8, hopping pattern ID 0 corresponds to start RB location hopping pattern {0, 4, 2, 6, 1, 5, 3, 7}; hopping pattern ID 1 corresponds to start RB location hopping pattern {4, 2, 6, 1, 5, 3, 7, 0}; hopping pattern ID 2 corresponds to start RB location hopping pattern {2, 6, 1, 5, 3, 7, 0, 4}; hopping pattern ID 3 corresponds to start RB location hopping pattern {6, 1, 5, 3, 7, 0, 4, 2}; hopping pattern ID 4 corresponds to start RB location hopping pattern {1, 5, 3, 7, 0, 4, 2, 6}; hopping pattern ID 5 corresponds to start RB location hopping pattern {5, 3, 7, 0, 4, 2, 6, 1}; hopping pattern ID 6 corresponds to start RB location hopping pattern {3, 7, 0, 4, 2, 6, 1, 5}; and hopping pattern ID 7 corresponds to start RB location hopping pattern {7, 0, 4, 2, 6, 1, 5, 3}.

The start RB location hopping pattern may be configured by one element of the start RB location hopping pattern that applies to the first hop of the first frequency hopping period, and the start RB location hopping pattern is determined by a cyclic pattern of a basic hopping pattern according to the one element. The one element of the start RB location hopping pattern may be indicated by an unused field of a DCI without data and without CSI if aperiodic SRS resource(s) are triggered by the DCI.

The {(n mod P_{F})+1}^{th} element in the start RB location hopping pattern may apply to the start RB location of the SRS resource in all hops of the n^{th} FH period. In this condition, the start RB location hopping pattern periodically applies to the every P_{F} FH periods.

The

$${\{ ( {n}_{SRS} = ⌊ \frac{{l}^{′}}{R} ⌋ ) mod {P}_{F} + 1 \}}^{th}$$

element of the start RB location hopping pattern may apply to the start RB location of the SRS resource in the l′^{th} hop, where R is the SRS repetition number. In this condition, the start RB location hopping pattern periodically changes in P_{F} contiguous FH periods.

The {(l′)mod P_{F}+1}^{th} element of the start RB location hopping pattern may apply to the start RB location of the SRS resource in the l′^{th} hop, where R is the SRS repetition number. In this condition, the start RB location hopping pattern periodically changes in P_{F}/R contiguous FH periods.

FIG. 8 is a schematic block diagram illustrating apparatuses according to one embodiment.

Referring to FIG. 8, the UE (i.e. the remote unit) includes a processor, a memory, and a transceiver. The processor implements a function, a process, and/or a method which are proposed in FIG. 6.

The UE comprises a receiver that receives a configuration on start RB location hopping pattern for an SRS resource configured with partial frequency sounding and with hops in each frequency hopping (FH) period, wherein the start RB location hopping pattern for partial frequency sounding factor P_{F} has P_{F} elements, and each element in the start RB location hopping pattern is selected from a set of values {0,1, . . . , P_{F}−1}; and a processor that determines the start RB location for each hop in each frequency hopping (FH) period according to the start RB location hopping pattern.

The start RB location hopping pattern may be directly configured to the SRS resource. Alternatively, the start RB location hopping pattern may be configured by a hopping pattern ID. In particular, for P_{F}=2, hopping pattern ID 0 corresponds to start RB location hopping pattern {0, 1}; and hopping pattern ID 1 corresponds to start RB location hopping pattern {1, 0}, for P_{F}=4, hopping pattern ID 0 corresponds to start RB location hopping pattern {0, 2, 1, 3}; hopping pattern ID 1 corresponds to start RB location hopping pattern {2, 1, 3, 0}; hopping pattern ID 2 corresponds to start RB location hopping pattern {1, 3, 0, 2}; and hopping pattern ID 3 corresponds to start RB location hopping pattern {3, 0, 2, 1}, and for P_{F}=8, hopping pattern ID 0 corresponds to start RB location hopping pattern {0, 4, 2, 6, 1, 5, 3, 7}; hopping pattern ID 1 corresponds to start RB location hopping pattern {4, 2, 6, 1, 5, 3, 7, 0}; hopping pattern ID 2 corresponds to start RB location hopping pattern {2, 6, 1, 5, 3, 7, 0, 4}; hopping pattern ID 3 corresponds to start RB location hopping pattern {6, 1, 5, 3, 7, 0, 4, 2}; hopping pattern ID 4 corresponds to start RB location hopping pattern {1, 5, 3, 7, 0, 4, 2, 6}; hopping pattern ID 5 corresponds to start RB location hopping pattern {5, 3, 7, 0, 4, 2, 6, 1}; hopping pattern ID 6 corresponds to start RB location hopping pattern {3, 7, 0, 4, 2, 6, 1, 5}; and hopping pattern ID 7 corresponds to start RB location hopping pattern {7, 0, 4, 2, 6, 1, 5, 3}.

The start RB location hopping pattern may be configured by one element of the start RB location hopping pattern that applies to the first hop of the first frequency hopping period, and the start RB location hopping pattern is determined by a cyclic pattern of a basic hopping pattern according to the one element. The one element of the start RB location hopping pattern may be indicated by an unused field of a DCI without data and without CSI if aperiodic SRS resource(s) are triggered by the DCI.

The {(n mod P_{F})+1}^{th} element in the start RB location hopping pattern may apply to the start RB location of the SRS resource in all hops of the n^{th} FH period. In this condition, the start RB location hopping pattern periodically applies to the every P_{F} FH periods.

The

$${\{ ( {n}_{SRS} = ⌊ \frac{{l}^{′}}{R} ⌋ ) mod {P}_{F} + 1 \}}^{th}$$

element of the start RB location hopping pattern may apply to the start RB location of the SRS resource in the l′^{th} hop, where R is the SRS repetition number. In this condition, the start RB location hopping pattern periodically changes in P_{F} contiguous FH periods.

The {(l′)mod P_{F}+1}^{th} element of the start RB location hopping pattern may apply to the start RB location of the SRS resource in the l′^{th} hop, where R is the SRS repetition number. In this condition, the start RB location hopping pattern periodically changes in P_{F}/R contiguous FH periods.

Referring to FIG. 8, the gNB (i.e. base unit) includes a processor, a memory, and a transceiver. The processors implement a function, a process, and/or a method which are proposed in FIG. 7.

The base unit comprises a transmitter that transmits a configuration on start RB location hopping pattern for an SRS resource configured with partial frequency sounding and with hops in each frequency hopping (FH) period, wherein the start RB location hopping pattern for partial frequency sounding factor P_{F} has P_{F} elements, and each element in the start RB location hopping pattern is selected from a set of values {0,1, . . . , P_{F}−1}; and a processor that determines the start RB location for each hop in each frequency hopping (FH) period according to the start RB location hopping pattern.

The start RB location hopping pattern may be directly configured to the SRS resource. Alternatively, the start RB location hopping pattern may be configured by a hopping pattern ID. In particular, for P_{F}=2, hopping pattern ID 0 corresponds to start RB location hopping pattern {0, 1}; and hopping pattern ID 1 corresponds to start RB location hopping pattern {1, 0}, for P_{F}=4, hopping pattern ID 0 corresponds to start RB location hopping pattern {0, 2, 1, 3}; hopping pattern ID 1 corresponds to start RB location hopping pattern {2, 1, 3, 0}; hopping pattern ID 2 corresponds to start RB location hopping pattern {1, 3, 0, 2}; and hopping pattern ID 3 corresponds to start RB location hopping pattern {3, 0, 2, 1}, and for P_{F}=8, hopping pattern ID 0 corresponds to start RB location hopping pattern {0, 4, 2, 6, 1, 5, 3, 7}; hopping pattern ID 1 corresponds to start RB location hopping pattern {4, 2, 6, 1, 5, 3, 7, 0}; hopping pattern ID 2 corresponds to start RB location hopping pattern {2, 6, 1, 5, 3, 7, 0, 4}; hopping pattern ID 3 corresponds to start RB location hopping pattern {6, 1, 5, 3, 7, 0, 4, 2}; hopping pattern ID 4 corresponds to start RB location hopping pattern {1, 5, 3, 7, 0, 4, 2, 6}; hopping pattern ID 5 corresponds to start RB location hopping pattern {5, 3, 7, 0, 4, 2, 6, 1}; hopping pattern ID 6 corresponds to start RB location hopping pattern {3, 7, 0, 4, 2, 6, 1, 5}; and hopping pattern ID 7 corresponds to start RB location hopping pattern {7, 0, 4, 2, 6, 1, 5, 3}.

The start RB location hopping pattern may be configured by one element of the start RB location hopping pattern that applies to the first hop of the first frequency hopping period, and the start RB location hopping pattern is determined by a cyclic pattern of a basic hopping pattern according to the one element. The one element of the start RB location hopping pattern may be indicated by an unused field of a DCI without data and without CSI if aperiodic SRS resource(s) are triggered by the DCI.

The {(n mod P_{F})+1}^{th} element in the start RB location hopping pattern may apply to the start RB location of the SRS resource in all hops of the n^{th} FH period. In this condition, the start RB location hopping pattern periodically applies to the every P_{F} FH periods.

The

$${\{ ( {n}_{SRS} = ⌊ \frac{{l}^{′}}{R} ⌋ ) mod {P}_{F} + 1 \}}^{th}$$

element of the start RB location hopping pattern may apply to the start RB location of the SRS resource in the l′^{th} hop, where R is the SRS repetition number. In this condition, the start RB location hopping pattern periodically changes in P_{F} contiguous FH periods.

The {(l′)mod P_{F}+1}^{th} element of the start RB location hopping pattern may apply to the start RB location of the SRS resource in the l′^{th} hop, where R is the SRS repetition number. In this condition, the start RB location hopping pattern periodically changes in P_{F}/R contiguous FH periods.

Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated by the appended claims rather than by the foregoing description. All changes which come within the meaning and range of equivalency of the claims are to be embraced within their scope.

1. A user equipment (UE), comprising:
at least one memory; and
at least one processor coupled with the at least one memory and configured to cause the UE to:
receive a configuration to enable start resource block (RB) location hopping for sounding reference signal (SRS) resource configured with partial frequency sounding; and
determine RB location hopping pattern for each partial frequency sounding factor (PF) as follows:
for P_{F}=2, a start RB location hopping pattern is {0,1}; and
for P_{F}=4, a start RB location hopping pattern is {0,2,1,3}.

2. The UE of claim 1, wherein, the start RB location hopping pattern is directly configured to the SRS resource.

3. The UE of claim 1, wherein, the start RB location hopping pattern is configured by a hopping pattern ID.

4. (canceled)

5. The UE of claim 1, wherein,
the start RB location hopping pattern is configured by one element of the start RB location hopping pattern that applies to a first hop of the a frequency hopping period, and
the start RB location hopping pattern is determined by a cyclic pattern of a basic hopping pattern according to the one element.

6. The UE of claim 5, wherein, the one element of the start RB location hopping pattern is indicated by an unused field of a downlink control information (DCI) without data and without channel state information (CSI) if aperiodic SRS resource(s) are triggered by the DCI.

7. The UE of claim 1, wherein, an {(n mod P_{F})+1}^{th} element in the start RB location hopping pattern applies to a start RB location of an SRS resource in all hops of an n^{th} FH period.

8. The UE of claim 7, wherein, the start RB location hopping pattern periodically applies to every P_{F} FH period.

9. The UE of claim 1, wherein, an
$${\{ ( {n}_{SRS} = ⌊ \frac{{l}^{′}}{R} ⌋ ) mod {P}_{F} + 1 \}}^{th}$$
element of the start RB location hopping pattern applies to a start RB location of an SRS resource in an l′^{th} hop, where R is an SRS repetition number.

10. The UE of claim 9, wherein, the start RB location hopping pattern periodically changes in P_{F} contiguous FH periods.

11. The UE of claim 1, wherein, an {(l′)mod P_{F}+1}^{th} element of the start RB location hopping pattern applies to a start RB location of an SRS resource in an l′^{th} hop, where R is an SRS repetition number.

12. The UE of claim 11, wherein, the start RB location hopping pattern periodically changes in P_{F}/R contiguous FH periods.

13. (canceled)

14. (canceled)

15. A base unit, comprising:
at least one memory, and
at least one processor coupled with the at least one memory and configured to cause the base unit to:
transmit a configuration on start resource block (RB) location hopping pattern for a sounding resource signal (SRS) resource configured with partial frequency sounding and with hops in each frequency hopping (FH) period, wherein the start RB location hopping pattern for partial frequency sounding factor P_{F} has P_{F} elements, and each element in the start RB location hopping pattern is selected from a set of values {0,1, . . . , P_{F}−1}; and
determine the start RB location for each hop in each frequency hopping (FH) period according to the start RB location hopping pattern.

16. A processor for wireless communication, comprising:
at least one controller coupled with at least one memory and configured to cause the processor to:
receive a configuration to enable start resource block (RB) location hopping for a sounding reference signal (SRS) resource configured with partial frequency sounding; and
determine an RB location hopping pattern for each partial frequency sounding factor (P_{F}) as follows:
for P_{F}=2, a start RB location hopping pattern is {0,1}; and
for P_{F}=4, a start RB location hopping pattern is {0,2,1,3}.

17. The processor of claim 16, wherein the start RB location hopping pattern is directly configured to the SRS resource.

18. The processor of claim 16, wherein the start RB location hopping pattern is configured by a hopping pattern ID.

19. The processor of claim 16, wherein,
the start RB location hopping pattern is configured by one element of the start RB location hopping pattern that applies to a first hop of a frequency hopping period, and
the start RB location hopping pattern is determined by a cyclic pattern of a basic hopping pattern according to the one element.

20. The processor of claim 16 wherein, an {(n mod P_{F})+1}^{th} element in the start RB location hopping pattern applies to a start RB location of an SRS resource in all hops of an n^{th} FH period.

21. The processor of claim 16, wherein an
$${\{ ( {n}_{SRS} = ⌊ \frac{{l}^{′}}{R} ⌋ ) mod {P}_{F} + 1 \}}^{th}$$
element of the start RB location hopping pattern applies to a start RB location of an SRS resource in an l′^{th} hop, where R is an SRS repetition number.

22. The processor of claim 16 wherein, an {(l′)mod P_{F}+1}^{th} element of the start RB location hopping pattern applies to a start RB location of an SRS resource in an l′^{th} hop, where R is an SRS repetition number.

23. A method performed by a user equipment (UE), the method comprising:
receiving a configuration to enable start resource block (RB) location hopping for a sounding reference signal (SRS) resource configured with partial frequency sounding; and
determining an RB location hopping pattern for each partial frequency sounding factor (P_{F}) as follows:
for P_{F}=2, a start RB location hopping pattern is {0,1}; and
for P_{F}=4, a start RB location hopping pattern is {0,2,1,3}.
